(19) United States
(12) Patent Application Publication
(10) Pub. No.: US 2010/0070509 A1
(43) Pub. Date: Mar. 18, 2010

(54) System And Method For High-Dimensional Similarity Search

(76) Inventors: Kai Li, Seattle, WA (US); Moses Charikar, Princeton, NJ (US); Qin Lv, Boulder, CO (US); William Josephson, Greenwich, CT (US); Zhe Wang, Princeton, NJ (US)

Correspondence Address: 24IP LAW GROUP USA, PLLC, 12 E. LAKE DRIVE, ANNAPOLIS, MD, 21403, US

(21) Appl. No.: 12/542,640

(22) Filed: Aug. 17, 2009

Related U.S. Application Data
(60) Provisional application No. 61/189,185, filed on Aug. 15, 2008.

(51) Int. Cl. G06F 17/30

(52) U.S. Cl. 707/747; 707/E17.052

(57) ABSTRACT

A computer-implemented method for searching a plurality of stored objects. Data objects are placed in a hash table, an ordered sequence of locations (probing sequence) in the hash table from a query object is generated and data objects in the hash table locations in the generated ordered sequence are examined to find objects whose relationships with the query object satisfy a certain predetermined function defined on pairs of objects.

### CROSS-REFERENCE TO RELATED APPLICATIONS

The present application claims the benefit of the filing date of U.S. Provisional Patent Application Ser. No. 61/189,185 entitled “Multi-probe LSH: Efficient indexing for high-dimensional similarity search” and filed on Aug. 15, 2008.

The aforementioned provisional patent application is hereby incorporated by reference in its entirety.

### STATEMENT REGARDING FEDERALLY SPONSORED RESEARCH OR DEVELOPMENT

This invention was made with government support under EIA-0101247, CCR-0205594, CCR-0237113, CNS-0509447 and DMS-0528414 awarded by the National Science Foundation. The government has certain rights in the invention.

### BACKGROUND OF THE INVENTION

1. Field Of The Invention

The present invention relates to systems and methods for performing high-dimensional similarity searches, and more specifically, to efficient indexing for high-dimensional similarity search systems and methods.

2. Brief Description Of The Related Art

The problem of similarity search refers to finding objects that have similar characteristics to the query object. When data objects are represented by d-dimensional feature vectors, the goal of similarity search for a given query object q, is to find the K objects that are closest to q according to a distance function in the d-dimensional space. The search quality is measured by the fraction of the nearest K objects one is able to retrieve.

A variety of computer-implemented similarity search systems and methods have been proposed in the past. For example, U.S. Patent Application Publication No. US-2006-0101060, which is hereby incorporated by reference in its entirety, disclosed a system and method for a content-addressable and -searchable storage system for managing and exploring massive amounts of feature-rich data such as images, audio or scientific data.

Similarity indices for high-dimensional data are very desirable for building content-based search systems for feature-rich data such as audio, images, videos, and other sensor data. Recently, locality sensitive hashing (LSH) and its variations have been proposed as indexing techniques for approximate similarity search. A significant drawback of these approaches is the requirement for a large number of hash tables in order to achieve good search quality.

Similarity searching in high-dimensional spaces has become increasingly important in databases, data mining, and search engines, particularly for content-based searching of feature-rich data such as audio recordings, digital photos, digital videos, and other sensor data. Since feature-rich data objects are typically represented as high-dimensional feature vectors, similarity searching is usually implemented as K-Nearest Neighbor (KNN) or Approximate Nearest Neighbors (ANN) searches in high-dimensional feature-vector space

An ideal indexing scheme for similarity search should have the following properties:
Accurate: A query operation should return desired results that are very close to those of the brute-force, linear-scan approach.
Time efficient: A query operation should take O(1) or O(log N) time where N is the number of data objects in the dataset.
Space efficient: An index should require a very small amount of space, ideally linear in the dataset size, not much larger than the raw data representation. For reasonably large datasets, the index data structure may even fit into main memory.
High-dimensional: The indexing scheme should work well for datasets with very high intrinsic dimensionalities (e.g. on the order of hundreds).
   In addition, the construction of the index data structure should be quick and it should deal with various sequences of insertions and deletions conveniently.

Current approaches do not satisfy all of these requirements. Previously proposed tree-based indexing methods for KNN search such as R-tree, K-D tree, SR-tree, navigating-nets and cover-tree return accurate results, but they are not time efficient for data with high (intrinsic) dimensionalities. See, for example, A. Beygelzimer, S. Kakade, and J. Langford, “Cover trees for nearest neighbor,” Proc. of the 23rd Intl. Conf. on Machine Learning, pages 97-104, 2006 and R. Krauthgamer and J. R. Lee, “Navigating nets: Simple algorithms for proximity search,” Proc. of the 15th ACM-SIAM Symposium on Discrete Algorithms (SODA), pages 798-807, 2004. It has been shown in that when the dimensionality exceeds about 10, existing indexing data structures based on space partitioning are slower than the brute-force, linear-scan approach.

For high-dimensional similarity search, the best-known indexing method is locality sensitive hashing (“LSH”). P. Indyk and R. Motwani, “Approximate nearest neighbors: Towards removing the curse of dimensionality,” Proc. of the 30th ACM Symposium on Theory of Computing, pages 604-613, 1998. The basic method uses a family of locality-sensitive hash functions to hash nearby objects in the high-dimensional space into the same bucket. To perform a similarity search, the indexing method hashes a query object into a bucket, uses the data objects in the bucket as the candidate set of the results, and then ranks the candidate objects using the distance measure of the similarity search. To achieve high search accuracy, the LSH method needs to use multiple hash tables to produce a good candidate set. Experimental studies show that this basic LSH method needs over a hundred and sometimes several hundred hash tables to achieve good search accuracy for high-dimensional datasets. See, for example, A. Gionis, P. Indyk, and R. Motwani, “Similarity search in high dimensions via hashing,” Proc. of 25th Intl. Conf. on Very Large Data Bases(VLDB), pages 518-529, 1999. Since the size of each hash table is proportional to the number of data objects, the basic approach does not satisfy the space-efficiency requirement.

The notion of locality sensitive hashing (LSH) was first introduced by Indyk and Motwani. P. Indyk and R. Motwani, “Approximate nearest neighbors: Towards removing the curse of dimensionality,” Proc. of the 30th ACM Symposium on Theory of Computing, pages 604-613, 1998. LSH function families have the property that objects that are close to each other have a higher probability of colliding than objects that are far apart. The basic LSH indexing method processes a similarity search, for a given query q, in two steps. The first step is to generate a candidate set by the union of all buckets that query q is hashed to. The second step ranks the objects in the candidate set according to their distances to query object q, and then returns the top K objects.

The main drawback of the basic LSH indexing method is that it may require a large number of hash tables to cover most nearest neighbors. For example, over 100 hash tables are needed to achieve 1.1-approximation in A. Gionis, P. Indyk, and R. Motwani, “Similarity search in high dimensions via hashing,” Proc. of 25th Intl. Conf. on Very Large Data Bases (VLDB), pages 518-529, 1999, and as many as 583 hash tables are used in J. Buhler, “Efficient large-scale sequence comparison by locality-sensitive hashing. Bioinformatics,” 17:419-428, 2001. The size of each hash table is proportional to the dataset size, since each table has as many entries as the number of data objects in the dataset. When the space requirements for the hash tables exceed the main memory size, looking up a hash bucket may require a disk I/O, causing substantial delay to the query process.

In a recent theoretical study, Panigrahy proposed an entropy-based LSH method that generates randomly “perturbed” objects near the query object, queries them in addition to the query object, and returns the union of all results as the candidate set. The intention of the method is to trade time for space requirements. R. Panigrahy, “Entropy based nearest neighbor search in high dimensions,” Proc. of ACM-SIAM Symposium on Discrete Algorithms (SODA), 2006. The entropy-based LSH scheme constructs its indices in a similar manner as the basic scheme, but uses a different query procedure. This scheme works as follows. Assuming one knows the distance Rₚ from the nearest neighbor p to the query q. In principle, for every hash bucket, one can compute the probability that p lies in that hash bucket (call this the success probability of the hash bucket). Note that this distribution depends only on the distance Rₚ. Given this information, it would make sense to query the hash buckets which have the highest success probabilities. However, performing this calculation is cumbersome. Instead, Panigrahy proposes a clever way to sample buckets from the distribution given by these probabilities. Each time, a random point p′ at distance Rₚ from q is generated and the bucket that p′ is hashed to is checked. This ensures that buckets are sampled with exactly the right probabilities. Performing this sampling multiple times will ensure that all the buckets with high success are probed.

However, this approach has some drawbacks: the sampling process is inefficient because perturbing points and computing their hash values are slow, and it will inevitably generate duplicate buckets. In particular, buckets with high success probability will be generated multiple times and much of the computation is wasteful. Although it is possible to remember all buckets that have been checked previously, the overhead is high when there are many concurrent. Since the total number of hash buckets may be large, only non-empty buckets are retained using regular hashing queries. Further, buckets with small success probabilities will also be generated and this is undesirable. Another drawback is that the sampling process requires knowledge of the nearest neighbor distance Rₚ, which is difficult to choose in a data-dependent way. If Rₚ is too small, perturbed queries may not produce the desired number of objects in the candidate set. If Rₚ is too large, it would require many perturbed queries to achieve good search quality. Thus, although the entropy-based method can reduce the space requirement of the basic LSH method, significant improvements are possible.

### SUMMARY OF THE INVENTION

The present invention is a new indexing scheme, which may be referred to as “multi-probe LSH,” that satisfies all the requirements of a good similarity indexing scheme. The invention builds on the basic LSH indexing method, but uses a carefully derived probing sequence to look up multiple buckets that have a high probability of containing the nearest neighbors of a query object. Two embodiments of schemes for computing the probing sequence are described: step-wise probing and query-directed probing. Other embodiments of the invention will be apparent to those of skill in the art. By probing multiple buckets in each hash table, the method of the present invention requires far fewer hash tables than previously proposed LSH methods. By picking the probing sequence carefully, it also requires checking far fewer buckets than entropy-based LSH.

The present inventors have implemented the conventional basic LSH and entropy-based LSH methods and have implemented the multi-probe LSH method of the present invention and evaluated all of them with two datasets. The first dataset contains 1.3 million web images, each represented by a 64-dimensional feature vector. The second is an audio dataset that contains 2.6 million words, each represented by a 192-dimensional feature vector. The evaluation showed that the multi-probe LSH method of the present invention substantially improves over the basic and entropy-based LSH methods in both space and time efficiency.

To achieve over 0.9 recall, the multi-probe LSH method of the present invention reduces the number of hash tables of the basic LSH method by a factor of 14 to 18 while achieving similar time efficiencies. In comparison with the entropy-based LSH method, multi-probe LSH reduces the space requirement by a factor of 5 to 8 and uses less query time, while achieving the same search quality

In a preferred embodiment, the present invention is a computer-implemented method for searching a plurality of stored objects comprising the steps of placing data objects in a hash table in memory (or other storage), generating an ordered sequence of locations (probing sequence) in the hash table from a query object with a processor or CPU, and examining data objects in the hash table locations in the generated ordered sequence with the processor or CPU to find objects whose relationships with the query object satisfy a certain predetermined function defined on pairs of objects. The predetermined function on pairs of objects may determine similarity, for example, based on a distance function computed on the pair of objects.

The predetermined function on pairs of objects may determine whether the pair of objects is similar, whether one object can be transformed to the other object by applying a set of specified transformations, whether a significant portion of one object is similar to a significant portion of the other object, and/or whether a significant portion of one object can be transformed to a significant portion of the other object by applying a set of specified transformations. In each step, a plurality of hash tables may be used rather than a single hash table.

The step of placing data objects in a hash table may comprise placing each data object in the hash table by applying a collection of hash functions to the object and using the result to determine a location in the hash table. The sequence of locations may be determined by first applying a collection of hash functions to a query object and using the result to determine the sequence of locations in the hash table.

A union of the data objects contained in hash table locations in the probing sequence may be examined to find data objects close to the query object. A prefix of the probing sequence is used to obtain a tradeoff of quality and running time.

In other embodiments, the sequence of locations may generated by computing collections of hash function values having small distances to the collection of hash function values generated for the query object. The collection of hash function values may be ordered by distance to the collection of hash function values for the query object. The distance function used may be, for example, a hamming distance or a weighted hamming distance. In a weighted hamming distance embodiment, the weights may be lower for those hash functions where objects close to the query object are more likely to have different hash function values from the hash function value for the query object.

The probing sequence may be obtained by sequence of transformations applied to the hash function values generated for the query object. The sequence of transformations may be computed from the query object. The set of sequences of transformations may be pre-computed and then one of them is selected based on the query object.

The step of placing data objects in a hash table may comprise the steps of producing a compact sketch for each object; using a feature extraction procedure and placing said data objects into multiple hash tables based upon said sketches. The step of generating an ordered sequence of hash table locations may comprise the steps of producing a compact sketch of a query object and identifying locations in the hash table based upon the compact sketch of the query object.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram illustrating a preferred embodiment of the method of the present invention.

FIGS. 2a and 2b are graphs illustrating the distribution of bucket distances of K nearest neighbors where W=0.7, M=16 and L=15.

FIG. 3 is a graph illustrating the probability of q's nearest neighbors falling into the neighboring slots.

FIG. 4 is a diagram illustrating generation of perturbation sequences in accordance with a preferred embodiment of the present invention. Vertical arrows represent shift operations, and horizontal arrows represent expand.operations.

FIGS. 5a and 5b are graphs illustrating the detailed relationship between search quality and the number of hash tables for the present invention compared to conventional search methods. The number of hash tables (in log scale) required by different LSH methods to achieve certain search quality (T=100 for both multi-probe LSH and entropy-based LSH) is shown. The multi-probe LSH of the present invention achieves higher recall with fewer number of hash tables.

FIGS. 6a and 6b are graphs illustrating comparisons of number of probes (in log scale) needed to achieve a certain search quality (L=10 for both audio and video) for a multi-probe LSH of the present invention versus an entropy-based LSH. The multi-probe LSH method uses a much fewer number of probes.

FIGS. 7a and 7b are graphs illustrating the number of duplicate buckets checked by the entropy-based LSH method. As seen in the graphs, a large fraction of buckets checked by entropy-based LSH are duplicate buckets, especially for smaller L.

FIGS. 8a and 8b are graphs illustrating the number of probes required (in log scale) using step-wise probing and query-directed probing for the multi-probe LSH method in accordance with the present invention to achieve certain search quality. The graphs illustrate that query-directed probing requires substantially fewer number of probes.

FIGS. 9a and 9b illustrate the number of n-step perturbation sequences picked by query-directed probing for an embodiment of the method of the present invention. Many 2,3,4-step sequences are picked before all 1-step sequences are picked.

FIGS. 10a and 10b are graphs illustration recall of multi-probe LSH in accordance with an embodiment of the present invention for different K (number of nearest neighbors). The multi-probe LSH achieves similar search quality for different K values.

### DETAILED DESCRIPTION OF THE PREFERRED EMBODIMENTS

The similarity search problem may also be considered as solving the approximate nearest neighbors problem, where the goal is to find K objects whose distances are within a small factor (1+ε) of the true K-nearest neighbors' distances. From this viewpoint, one also can measure search quality by comparing the distances to the query for the K objects retrieved to the corresponding distances of the K nearest objects. The present invention provides a good indexing method for similarity search of large-scale datasets that can achieve high search quality with high time and space efficiency.

The basic idea of locality sensitive hashing (LSH) is to use hash functions that map similar objects into the same hash buckets with high probability. Performing a similarity search query on an LSH index consists of two steps: (1) using LSH functions to select “candidate” objects for a given query q, and (2) ranking the candidate objects according to their distances to q.

To address the issues associated with the basic and entropy-based LSH methods as discussed above, the present invention employs a new multi-probe LSH method, which uses a more systematic approach to explore hash buckets. Ideally, one would like to examine the buckets with the highest success probabilities. The present invention incorporates a simple approximation for these success probabilities and uses it to order hash buckets for exploration. Moreover, the ordering of hash buckets does not depend on the nearest neighbor distance as in the entropy-based approach. Experiments demonstrate that the approximation in the present invention works quite well. In using this technique, high recall with substantially fewer hash tables is achieved.

The multi-probe LSH method of the present invention uses a carefully derived probing sequence to check multiple buckets that are likely to contain the nearest neighbors of a query object. Given the property of locality sensitive hashing, if an object that is close to a query object q is not hashed to the same bucket as q, it is likely to be in a bucket that is “close by” (i.e., the hash values of the two buckets only differ slightly). The present invention locates these “close by” buckets, thus increasing the chance of finding the objects that are close to q.

A “hash perturbation vector” is defined herein to be a vector Δ=(δ₁, . . . ,δ_{M}). Given a query q, the basic LSH method checks the hash bucket g(q)=(h₁(q), . . . ,h_{M}(q)). When we apply the perturbation Δ, we will probe the hash bucket g(q)+Δ.

Recall that the LSH functions we use are of the form

$${h}_{a , b} ( v ) = ⌊ \frac{a \cdot v + w}{W} ⌋ .$$

If we pick W to be reasonably large, with high probability, similar objects should hash to the same or adjacent values (i.e. differ by at most 1). Hence we restrict our attention to perturbation vectors Δ with δ₁ε{−1,0,1}.

Each perturbation vector is directly applied to the hash values of the query object, thus avoiding the overhead of point perturbation and hash value computations associated with the entropy-based LSH method. The present invention generates a sequence of perturbation vectors such that each vector in the sequence maps to a unique set of hash values so that the system and method never probe a hash bucket more than once.

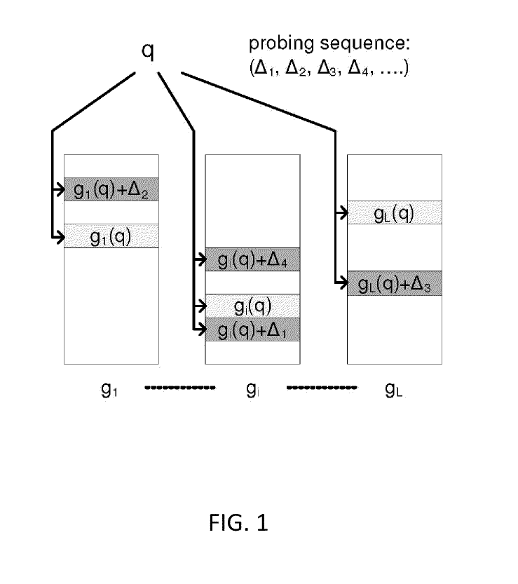

FIG. 1 illustrates how the multi-probe LSH method of the present invention works. Multi-probe LSH uses a sequence of hash perturbation vectors to probe multiple hash buckets. In FIG. 1, gᵢ(q) is the hash value of query q in the i-th table, Δⱼ is a hash perturbation vector, and (Δ₁, Δ₂, . . . ) is a probing sequence. Further, gᵢ(q)+Δ₁ is the new hash value after applying perturbation vector Δ₁ to gᵢ(q); it points to another hash bucket in the table. By using multiple perturbation vectors the present invention locates more hash buckets which are likely to be close to the query object's buckets and may contain q's nearest neighbors. Next, the issue of generating a sequence of perturbation vectors is addressed.

An n-step perturbation vector A has exactly n coordinates that are non-zero. This corresponds to probing a hash bucket which differs in n coordinates from the hash bucket of the query. Based on the property of locality sensitive hashing, buckets that are one step away (i.e., only one hash value is different from the M hash values of the query object) are more likely to contain objects that are close to the query object than buckets that are two steps away.

This motivates a “step-wise” probing method, which first probes all the 1-step buckets, then all the 2-step buckets, and so on. For an LSH index with L hash tables and M hash functions per table, the total number of n-step buckets is

$$L \times ( \frac{M}{n} ) \times {2}^{n}$$

and the total number of buckets within s steps is

$$L \times {\sum }_{n - 1}^{s} ( \frac{M}{n} ) \times {2}^{n} .$$

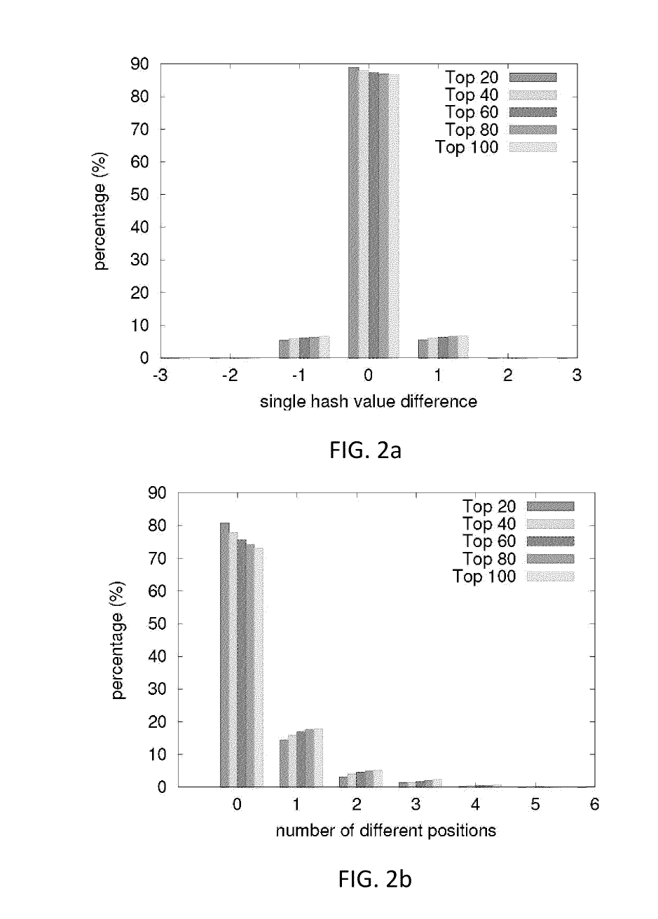

FIGS. 2a and 2b show the distribution of bucket distances of K nearest neighbors. FIG. 2a shows the difference of a single hash value (δᵢ) and FIG. 2b shows the number of hash values (out of M) that differ from the hash values of the query object (n-step buckets). As one can see from the plots, almost all of the individual hash values of the K nearest neighbors are either the same (δᵢ=0) as that of the query object or differ by just −1 or +1. Also, most K nearest neighbors are hashed to buckets that are within 2 steps of the hashed bucket of the query object.

Using the step-wise probing method, all coordinates in the hash values of the query q are treated identically, i.e., all have the same chance of being perturbed, and we consider both the possibility of adding 1 and subtracting 1 from each coordinate to be equally likely. In fact, a more refined construction of a probing sequence is possible by considering how the hash value of q is computed. Note that each hash function

$${h}_{a , b} ( q ) = ⌊ \frac{a \cdot q + w}{W} ⌋$$

first maps q to a line. The line is divided into slots (intervals) of length W numbered from left to right and the hash value is the number of the slot that q falls into. A point p close to q is likely to fall in either the same slot as q or an adjacent slot. In fact, the probability that p falls into the slot to the right (left) of q depends on how close q is to the right (left) boundary of its slot. Thus the position of q within its slot for each of the M hash functions is potentially useful in determining perturbations worth considering. Next, we describe a more sophisticated method to construct a probing sequence that takes advantage of such information.

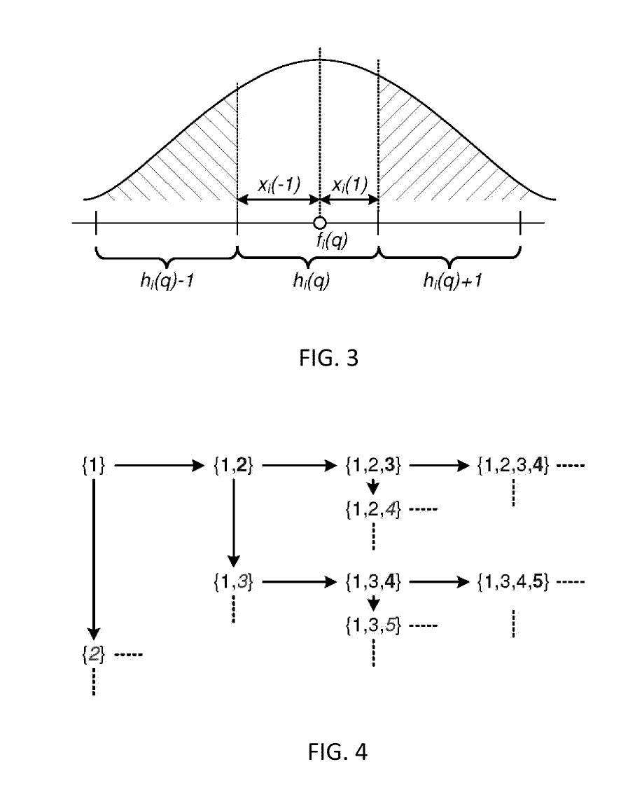

FIG. 3 illustrates the probability of q's nearest neighbors falling into the neighboring slots. Here, fᵢ(q)=aᵢ·q+bᵢ is the projection of query q on to the line for the i-th hash function and

$${h}_{i} ( q ) = ⌊ \frac{{a}_{i} \cdot q + {b}_{i}}{W} ⌋$$

is the slot to which q is hashed. For δε{−1,+1}, let xᵢ(δ) be the distance of q from the boundary of the slot hᵢ(q)+δ, then xᵢ(−1)=fᵢ(q)−hᵢ(q)×W and xᵢ(1)=W−−xᵢ(−1). For convenience, define xᵢ(0)=0. For any fixed point p, fᵢ(p)−fᵢ(q) is a Gaussian random variable with mean 0 (here the probability distribution is over the random choices of aᵢ). The variance of this random variable is proportional to ∥p−q∥₂². We assume that W is chosen to be large enough so that for all points p of interest, p falls with high probability in one of the three slots numbered hᵢ(q), hᵢ(q)−1 or hᵢ(q)+1. Note that the probability density function of a Gaussian random variable is e^{-x}^{²}^{/2σ}^{²} (scaled by a normalizing constant). Thus the probability that point p falls into slot hᵢ(q)+δ can be estimated by:

Pr[hᵢ(p)=hᵢ(q)+δ]≈e^{-Cx}^{ᵢ}^{(δ)}^{²}

where C is a constant depending on ∥p−q∥₂.

We now estimate the success probability (finding a p that is close to q) of a perturbation vector Δ=(δ₁, . . . ,δ_{M}).

$$Pr [ g ( p ) = g ( q ) + Δ ] = {\prod }_{i = 1}^{M} Pr [ {h}_{i} ( p ) = {h}_{i} ( q ) + {δ}_{i} ] \\ = {\prod }_{i = 1}^{M} {e}^{- {{Cx}_{i} ( {δ}_{i} )}^{2}} = {e}^{- C {\sum }_{i} {x}_{i} ( {( {δ}_{i} )}^{2} )} .$$

This suggests that the likelihood that perturbation vector Δ will find a point close to q is related to

$$score ( Δ ) = {\sum }_{i = 1}^{M} {{x}_{i} ( {δ}_{i} )}^{2} .$$

Perturbation vectors with smaller scores have higher probability of yielding points near to q. Note that the score of Δ is a function of both Δ and the query q. This is the basis for a new “query-directed” probing method in accordance with a preferred embodiment of the present invention, which orders perturbation vectors in increasing order of their (query dependent) scores.

A naive way to construct the probing sequence would be to compute scores for all possible perturbation vectors and sort them. However, there are L×(2^{M}−1) perturbation vectors and only a small fraction of them will be used. Thus, explicitly generating all perturbation vectors is unnecessarily wasteful. Thus, a preferred embodiment of the present invention uses a more efficient way to generate perturbation vectors in increasing order of their scores.

First note that the score of a perturbation vector Δ depends only on the non-zero coordinates of Δ (since xᵢ(δ)=0 for δ=0). Perturbation vectors with low scores will have a few non-zero coordinates. In generating perturbation vectors, we will represent only the non-zero coordinates as a set of (i, δi) pairs. An (i, δ) pair represents adding δ to the i-th hash value of q.

Given the query object q and the hash functions hᵢ for i=1, . . . ,M corresponding to a single hash table, we first compute xᵢ(δ) for i=1, . . . ,M and δε{−1, +1}. We sort these 2M values in increasing order. Let zⱼ denote the jth element in this sorted order. Let πⱼ=(i, δ) if zⱼ=xᵢ(δ). This represents the fact that the value xᵢ(δ) is the jth smallest in the sorted order. Note that since xᵢ(−1)+xᵢ(+1)=W , if πⱼ=(i, δ), then π_{2M+1-j}=(i, −δ). We now represent perturbation vectors as a subset of {1, . . . , 2M}, referred to as a perturbation set. Each perturbation set corresponds to one perturbation vector, while a probing sequence contains multiple perturbation vectors. For each such perturbation set A, the corresponding perturbation vector Δ_{A} is obtained by taking the set of coordinate perturbations {πⱼ|jεA}. Every perturbation set A can be associated

with a score score

$$( A ) = {\sum }_{j ∈ A} {z}_{j}^{2} ,$$

which is exactly the same as the score of the corresponding perturbation vector Δ_{A}. Given the sorted order π of (i, δᵢ) pairs and the values zⱼ, j=1, . . . ,2M, the problem of generating perturbation vectors now reduces to the problem of generating perturbation sets in increasing order of their scores.

We define two operations on a perturbations as follows:
shift(A): This operation replaces max(A) by 1+max(A). E.g. shift({1,3,4})={1,3,4,5}.
expand(A): This operation adds the element 1+max(A) to the set A. E.g. expand({1,3,4})={1,3,4,5}.

Algorithm 1 shows how to generate the first T perturbation sets.

Algorithm 1 Generate T perturbation sets

A_{O} = {1}
minHeap_insert(A_{O}, score(A_{O}))
for i = 1 to T do

repeat

Aᵢ = minHeap_extractMin( )
Aₛ = shift(Aᵢ)
minHeap_insert(Aₛ, score(Aₛ))
Aₑ = expand(A)
minHeap_insert(Aₑ, score(Aₑ))

until valid(Aᵢ)
output Aᵢ

end for

A min-heap is used to maintain the collection of candidate perturbation sets such that the score of a parent set is not larger than the score of its child set. The heap is initialized with the set {1}. Each time we remove the top node (set Aᵢ) and generate two new sets shift(Aᵢ) and expand(Aᵢ) (see FIG. 4). Only the valid top node (set Aᵢ) is output. Note, for every j=1, . . . ,M, πⱼ and π_{2M+1-j} represent opposite perturbations on the same coordinate. Thus, a valid perturbation set A must have at most one of the two elements {j, 2M+1−j} for every j. We also consider any perturbation set containing value greater than 2M to be invalid.

We mention two properties of the shift and expand operations which are important for establishing the correctness of the above procedure
For a perturbation set A, the scores for shift(A) and expand(A) are greater than the score for A.
For any perturbation set A, there is a unique sequence of shift and expand operations which will generate the set A starting from {1}.
   Based on these two properties, it is easy to establish the following correctness property by induction on the sorted order of the sets (by score).
Claim 1. The procedure described correctly generates all valid perturbation sets in increasing order of their score
Claim 2. The number of elements in the heap at any point of time is one more than the number of min-heap_extract-min operations performed.

To simplify the exposition, we have described the process of generating perturbation sets for a single hash table. In fact, we will need to generate perturbation sets for each of the L hash tables. For each hash table, we maintain a separate sorted order of (i, δ) pairs and zⱼ values, represented by πⱼ^{t} and zⱼ^{t} respectively. However we can maintain a single heap to generate the perturbation sets for all tables simultaneously. Each candidate perturbation set in the heap is associated with a table t. Initially we have L copies of the set {1}, each associated with a different table. For a perturbation set A for table t, the score is a function of the zⱼ^{t} values and the corresponding perturbation vector Δ_{A} is a function of the πⱼ^{t} values. When set A associated with table t is removed from the heap, the newly generated sets shift(A) and expand(A) are also associated with table t.

The query-directed probing approach described above generates the sequence of perturbation vectors at query time by maintaining a heap and querying this heap repeatedly. We now describe a method to avoid the overhead of maintaining and querying such a heap at query time. In order to do this, we pre-compute a certain sequence and reduce the generation of perturbation vectors to performing lookups instead of heap queries and updates.

Note that the generation of the sequence of perturbation vectors can be separated into two parts: (1) generating the sorted order of perturbation sets, and (2) mapping each perturbation set into a perturbation vector. The first part requires the zⱼ values while the second part requires the mapping π from {1, . . . , 2M} to (i, δ) pairs. Both these are functions of the query q.

As we will explain shortly, it turns out that we know the distribution of the zⱼ values precisely and can compute E[zⱼ²] for each j. This motivates the following optimization: We approximate the zⱼ² values by their expectations. Using this approximation, the sorted order of perturbation sets can be pre-computed (since the score of a set is a function of the zⱼ² values). The generation process is exactly the same as described above, but uses the E[zⱼ²] values instead of their actual values. This can be done independently of the query q. At query time, we compute the mapping πⱼ^{t} as a function of query q. (separately for each hash table t). These mappings are used to convert each perturbation set in the pre-computed order into L perturbation vectors, one for each of the L hash tables. This pre-computation reduces the query time overhead of dynamically generating the perturbation sets at query time.

To complete the description, we need to explain how to obtain E[zⱼ²]. Recall that the zⱼ values are the xᵢ(δ) values in sorted order. Note xᵢ(δ) is uniformly distributed in [0,W] and further xᵢ(−1)+xᵢ(+1)=W. Since each of the M hash functions is chosen independently, the xᵢ(δ) values are independent of the xⱼ(δ′) values for j≠i. The joint distribution of the zⱼ values for j=1, . . . ,M is then the following: pick M numbers uniformly and at random from the interval [0, W/2]. zⱼ is the j-th largest number in this set. This is a well studied distribution, referred to as the order statistics of the uniform distribution in [0,W]. Using known facts about this distribution, we get that for

$$j ∈ \{ 1 , … , M \} , \\ E [ {z}_{j} ] = \frac{i}{2 ( M + 1 )} W$$

$$and$$

$$E [ {z}_{j}^{2} ] = \frac{j ( j + 1 )}{4 ( M + 1 ) ( M + 2 )} {W}^{2} .$$

### Further, for

$$j ∈ \{ M + 1 , … , 2 M \} , \\ \begin{matrix}E [ {z}_{j}^{2} ] = E [ {( W - {z}_{2 M + 1 - j} )}^{2} ] \\ = {W}^{2} ( 1 - \frac{2 M + 1 - j}{M + 1} + \frac{( 2 M + 1 - j ) ( 2 M + 2 - j )}{4 ( M + 1 ) ( M + 2 )} )\end{matrix}$$

These values are used in determining the pre-computed order of perturbation sets as described earlier.

### Examples

Several examples of preferred embodiments of the invention are described herein in comparison to conventional systems and methods, including the evaluation datasets, evaluation benchmarks, evaluation metrics, and some implementation details.

Two datasets are used in the examples. The dataset sizes were chosen such that the index data structure of the basic LSH method can entirely fit into the main memory. Since the entropy-based and multi-probe LSH methods require less memory than the basic LSH method, it was possible to compare the in-memory indexing behaviors of all three approaches. The two datasets are as follows:
Image Data: The image dataset is obtained from Stanford's WebBase project, which contains images crawled from the web. We only picked images that are of JPEG format and are larger than 64×64 in size. The total number of images picked is 1.3 million. For each image, we use the extractcolorhistogram tool from the FIRE image search engine to extract a 64-dimensional color histogram.
Audio Data: The audio dataset comes from the LDC SWITCHBOARD-1 collection. It is a collection of about 2400 two-sided telephone conversations among 543 speakers from all areas of the United States. The conversations are split into individual words based on the human transcription. In total, the audio dataset contains 2.6 million words. For each word segment, we then use the Marsyas library to extract feature vectors by taking a 512-sample sliding window with variable stride to obtain 32 windows for each word. For each of the 32 windows, we extract the first six MFCC parameters, resulting in a 192-dimensional feature vector for each word.
   Table 1 below summarizes the number of objects in each dataset and the dimensionality of the feature vectors.

| Dataset | No. of Objects | No. of Dimensions | Total Size |
|---|---|---|---|
| Image | 1,312,581 | 64 | 336 MB |
| Audio | 2,663,040 | 192 | 2.0 GB |

For each dataset, we created an evaluation benchmark by randomly picking 100 objects as the query objects, and for each query object, the ground truth (i.e., the ideal answer) is defined to be the query object's K nearest neighbors (not including the query object itself), based on the Euclidean distance of their feature vectors. Unless otherwise specified, K is 20 in our experiments.

The performance of a similarity search system can be measured in three aspects: search quality, search speed, and space requirement. Ideally, a similarity search system should be able to achieve high-quality search with high speed, while using a small amount of space.

Search quality is measured by recall. Given a query object q, let I(q) be the set of ideal answers (i.e., the k nearest neighbors of q), let A(q) be the set of actual answers, then

$$recall = \frac{\vert A ( q ) ⋂ I ( q ) \vert}{\vert I ( q ) \vert}$$

In the ideal case, the recall score is 1.0, which means all the k nearest neighbors are returned. Note that we do not need to consider precision here, since all of the candidate objects (i.e., objects found in one of the checked hash buckets) will be ranked based on their Euclidean distances to the query object and only the top k candidates will be returned.

For comparison purposes, we will also present search quality results in terms of error ratio (or effective error), which measures the quality of approximate nearest neighbor search. As defined in A. Gionis, P. Indyk, and R. Motwani, “Similarity search in high dimensions via hashing,” Proc. of 25th Intl. Conf. on Very Large Data Bases (VLDB), pages 518-529, 1999:

$$Error ratio = \frac{1}{\vert Q \vert K} {\sum }_{q ∈ Q} {\sum }_{k = 1}^{K} \frac{{d}_{{LSH}_{k}}}{{d}_{k}^{*}}$$

where d_{LSH}_{ₖ} is the k-th nearest neighbor found by a LSH method, and d*ₖ is the true k-th nearest neighbor. In other words, it measures how close the distances of the K nearest neighbors found by LSH are compared to the exact K nearest neighbors' distances.

Search speed is measured by query time, which is the time spent to answer a query. Space requirement is measured by the total number of hash tables needed, and the total memory usage.

All performance measures are averaged over the 100 queries. Also, since the hash functions are randomly picked, each experiment is repeated 10 times and the average is reported.

We have implemented the three different LSH methods as discussed in previous sections: basic, entropy, and multi-probe. For the multi-probe LSH method of the present invention, we have implemented both step-wise probing and query-directed probing.

The default probing method for multi-probe LSH is query-directed probing. For all the hash tables, only the object ids are stored in the hash buckets. A separate data structure stores all the vectors, which can be accessed via object ids. We use an object id bitmap to efficiently union objects found in different hash buckets. As a baseline comparison, we have also implemented the brute-force method, which linearly scans through all the feature vectors to find the k nearest objects. All methods are implemented using the C programming language. Also, each method reads all the feature vectors into main memory at startup time.

We have experimented with different parameter values for the LSH methods and picked the ones that give bestperformance. In the results, unless otherwise specified, the default values are W=0.7, M=16 for the image dataset and W=24.0, M=11 for the audio dataset. For the entropy-based LSH method, the perturbation distance Rp=0.04 for the image dataset and Rp=4.0 for the audio dataset.

The evaluation is done on a PC with one dual-processor Intel Xeon 3.2 GHz CPU with 1024 KB L2 cache. The PC system has 6 GB of DRAM and a 160 GB 7,200 RPM SATA disk. It runs the Linux operating system with a 2.6.9 kernel.

In this section, we report the evaluation results of the three LSH methods using the image dataset and the audio dataset. We are interested in answering the question about the space requirements, search time and search quality trade-offs for different LSH methods.

The main result is that the multi-probe LSH method is much more space efficient than the basic LSH and entropy-based LSH methods to achieve various search quality levels and it is more time efficient than the entropy-based LSH method.

Table 2 shows the average results of the basic LSH, entropy-based LSH and multi-probe LSH methods using 100 random queries with the image dataset and the audio dataset.

| | | error | query | #hash | space | | | error | query | #hash | space |
|---|---|---|---|---|---|---|---|---|---|---|---|
| recall | method | ratio | time (s) | tables | ratio | recall | method | ratio | time (s) | tables | ratio |
| 0.96 | basic | 1.027 | 0.049 | 44 | 14.7 | 0.94 | basic | 1.002 | 0.191 | 69 | 13.8 |
| | entropy | 1.023 | 0.094 | 21 | 7.0 | | entropy | 1.002 | 0.242 | 44 | 8.8 |
| | multi-probe | 1.015 | 0.050 | 3 | 1.0 | | multi-probe | 1.002 | 0.199 | 5 | 1.0 |
| 0.93 | basic | 1.036 | 0.044 | 30 | 15.0 | 0.92 | basic | 1.003 | 0.174 | 61 | 15.3 |
| | entropy | 1.044 | 0.092 | 11 | 5.5 | | entropy | 1.003 | 0.203 | 25 | 6.3 |
| | multi-probe | 1.053 | 0.039 | 2 | 1.0 | | multi-probe | 1.002 | 0.163 | 4 | 1.0 |
| 0.90 | basic | 1.049 | 0.029 | 18 | 18.0 | 0.90 | basic | 1.004 | 0.133 | 49 | 16.3 |
| | entropy | 1.036 | 0.078 | 6 | 6.0 | | entropy | 1.003 | 0.181 | 19 | 6.3 |
| | multi-probe | 1.029 | 0.031 | 1 | 1.0 | | multi-probe | 1.003 | 0.143 | 3 | 1.0 |

| | |
|---|---|
| (a) image dataset | (b) audio dataset |

We have experimented with different number of hash tables L (for all three LSH methods) and different number of probes T (i.e., number of extra hash buckets to check, for the multi-probe LSH method and the entropy-based LSH method). For each dataset, the table reports the query time, the error ratio and the number of hash tables required, to achieve three different search quality (recall) values.

The results show that the multi-probe LSH method is significantly more space efficient than the basic LSH method. For both the image data set and the audio data set, the multi-probe LSH method reduces the number of hash tables by a factor of 14 to 18. In all cases, the multi-probe LSH method has similar query time to the basic LSH method.

The space efficiency implication is dramatic. Since each hash table entry consumes about 16 bytes in our implementation, 2 gigabytes of main memory can hold the index data structure of the basic LSH method for about 4-million images to achieve a 0.93 recall. On the other hand, when the same amount of main memory is used by the multi-probe LSH indexing data structures, it can deal with about 60 million images to achieve the same search quality.

The results in Table 2 also show that the multi-probe LSH method of the present invention is substantially more space and time efficient than the entropy-based approach. For the image dataset, the multi-probe LSH method reduces the number of hash tables required by the entropy-based approach by a factor of 7.0, 5.5, and 6.0 respectively for the three recall values, while reducing the query time by half. For the audio data set, multi-probe LSH reduces the number of hash tables by a factor of 8.8, 6.3, and 6.3 for the three recall values, while using less query time.

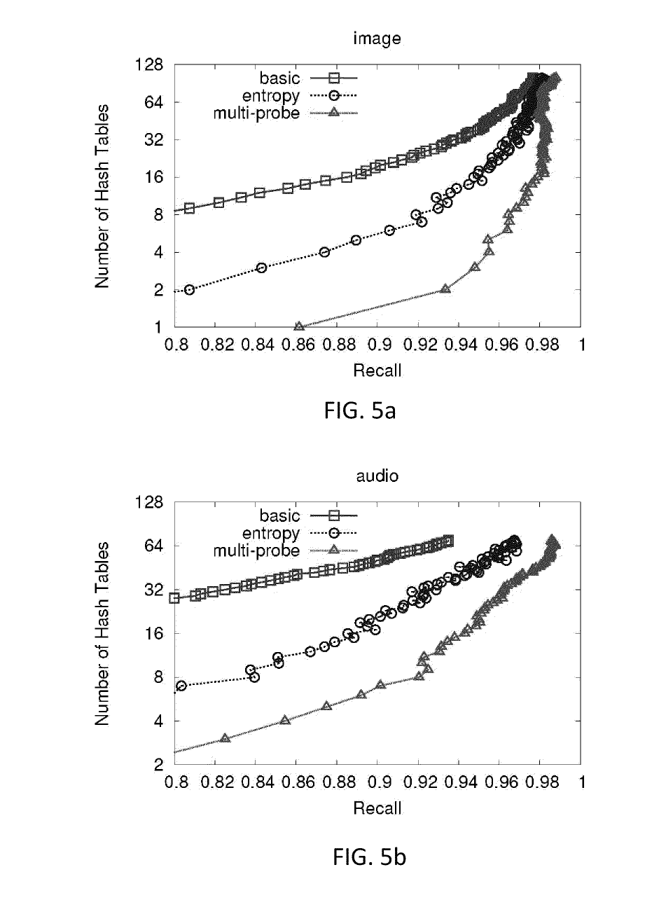

FIG. 5 shows the detailed relationship between search quality and the number of hash tables for all three indexing approaches. Here, for easier comparison, we use the same number of probes (T=100) for both multi-probe LSH and entropy-based LSH. It shows that for most recall values, the multi-probe LSH method reduces the number of hash tables required by the basic LSH method by an order of magnitude. It also shows that the multi-probe method is better than the entropy-based LSH method by a significant factor.

Although both multi-probe and entropy-based methods visit multiple buckets for each hash table, they are very different in terms of how they probe multiple buckets. The entropy-based LSH method generates randomly perturbed objects and use LSH functions to hash them to buckets, whereas the multi-probe LSH method uses a carefully derived probing sequence based on the hash values of the query object. The entropy-based LSH method is likely to probe previously visited buckets, whereas the multi-probe LSH method always visits new buckets.

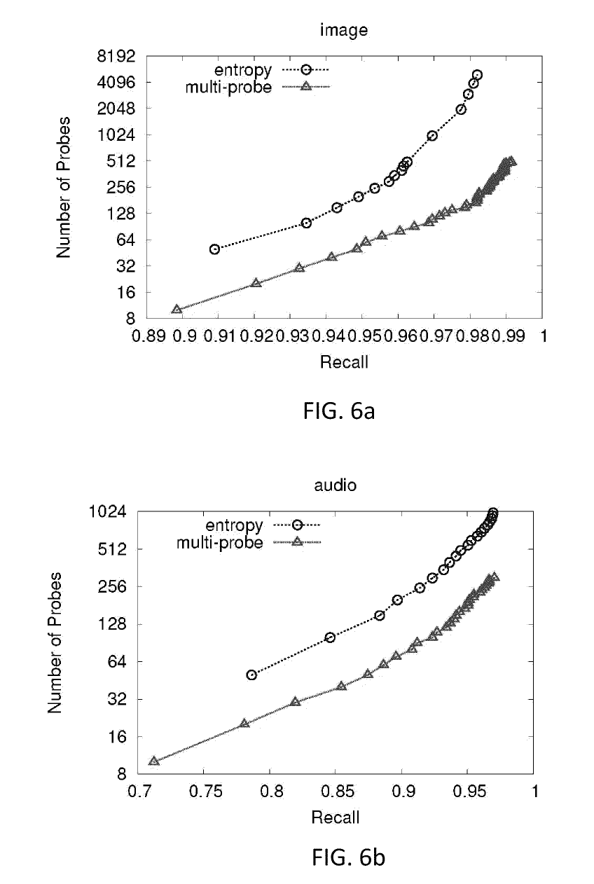

To compare the two approaches in detail, we are interested in answering two questions. First, when using the same number of hash tables, how many probes does the multi-probe LSH method need, compared with the entropy-based approach? As we can see in FIG. 6 (note that the y axis is in log scale of 2), multi-probe LSH requires substantially fewer number of probes.

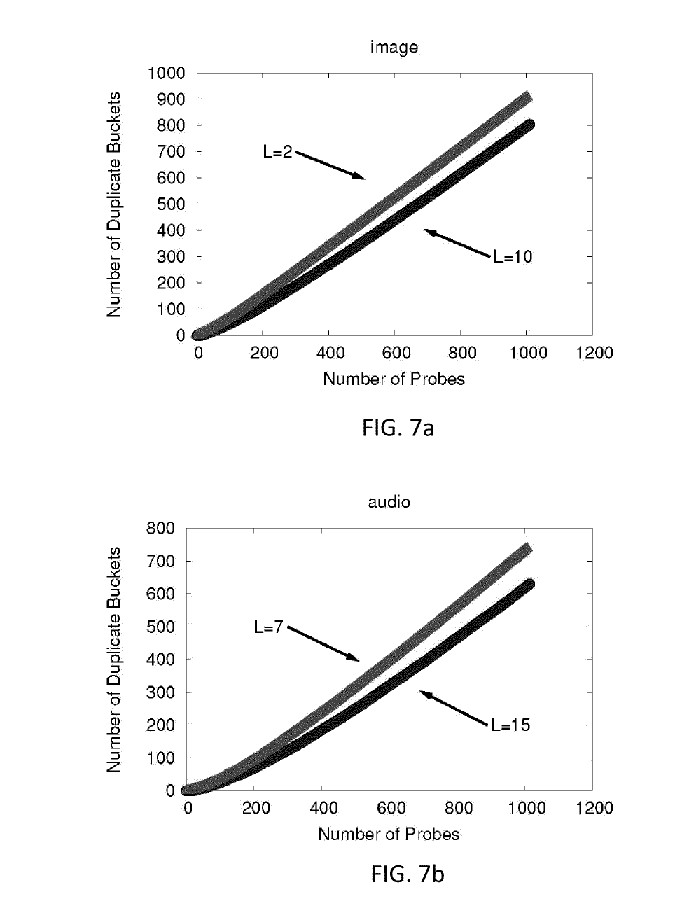

Second, how often does the entropy-based approach probe previously visited buckets (duplicate buckets)? As we can see in FIG. 7, the number of duplicate buckets is over 900 for the image dataset and over 700 for the audio dataset, while the total number of buckets checked is 1000. Such redundancy becomes worse with fewer hash tables.

Results also were obtained for differing embodiments of the multi-probe LSH method of the present invention. Specifically, the results show differences between the query-directed and step-wise probing sequences for the multi-probe LSH indexing method. The results show that query-directed probing sequence is superior to the step-wise probing sequence.

First, with similar query times, the query-directed probing sequence requires significantly fewer hash tables than the step-wise probing sequence. Table 3 shows the space requirements of using the two probing sequences to achieve three recall precisions with similar query times.

| | | | error | query | #hash | | | | error | query | #hash |
|---|---|---|---|---|---|---|---|---|---|---|---|
| | #probes | recall | ratio | time(s) | tables | | #probes | recall | ratio | time(s) | tables |
| 1-step | 320 | 0.933 | 1.027 | 0.042 | 10 | 1-step | 330 | 0.885 | 1.004 | 0.224 | 15 |
| query-directed | 400 | 0.937 | 1.020 | 0.040 | 1 | query-directed | 160 | 0.885 | 1.004 | 0.103 | 3 |
| 1, 2-step | 5120 | 0.960 | 1.017 | 0.071 | 10 | 1, 2-step | 3630 | 0.947 | 1.001 | 0.462 | 15 |
| query-directed | 450 | 0.960 | 1.024 | 0.060 | 2 | query-directed | 450 | 0.947 | 1.001 | 0.323 | 3 |
| 1, 2, 3-stop | 49920 | 0.969 | 1.012 | 0.132 | 10 | 1, 2, 3-step | 23430 | 0.973 | 1.001 | 0.724 | 15 |
| query-directed | 600 | 0.969 | 1.019 | 0.064 | 2 | query-directed | 900 | 0.974 | 1.001 | 0.444 | 3 |

| | |
|---|---|
| (a) image data-set | (b) audio dataset |

For the image dataset, the query-directed probing sequence reduces the number of hash tables by a factor of 5, 10 and 10 for the three cases. For the audio dataset, it reduces the number of hash tables by a factor of 5 for all three cases.

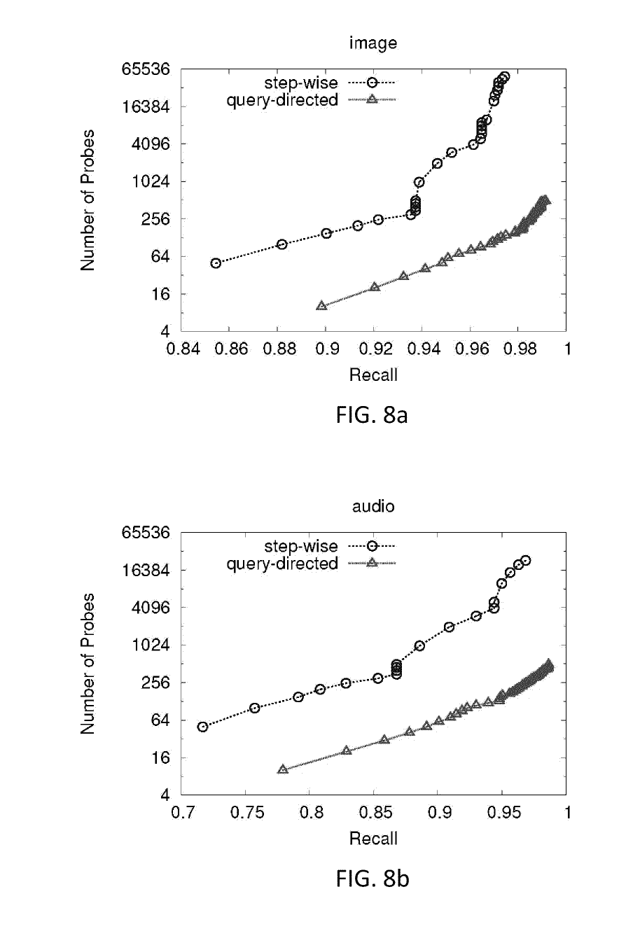

Second, with the same number of hash tables, the query-directed probing sequence requires far fewer probes than the step-wise probing sequence to achieve the same recall precisions. FIG. 8 shows the relationship between the number of probes and recall precisions for both approaches when they use the same number of hash tables (10 for image data and 15 for audio data). The results indicate that the query-directed probing sequence can reduce the number of probes typically by an order of magnitude for various recall values.

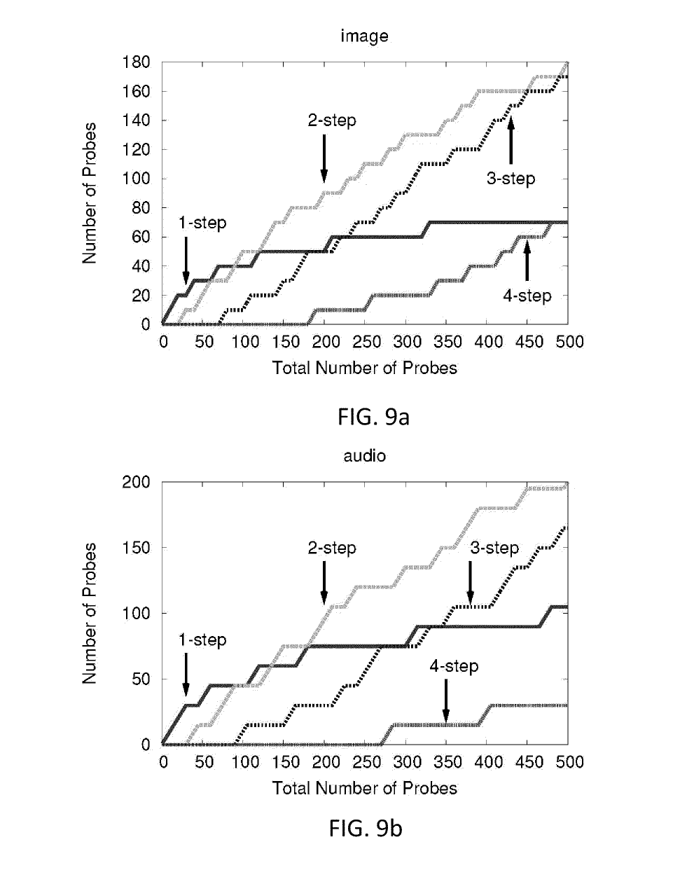

The main reason for the big gap between the two sequences is that many similar objects are not in the buckets 1 step away from the hashed buckets. In fact, some are several steps away from the hashed buckets. The step-wise probing visits all 1-step buckets, then all 2-step buckets, and so on. The query-directed probing visits buckets with high success probability first. FIG. 9 shows the number of n-step (n=1, 2, 3, 4) buckets picked by the query-directed probing method, as a function of the total number of probes. The figure clearly shows that many 2,3,4-step buckets are picked before all the 1-step buckets are picked. For example, for the image dataset, of the first 200 probes, the number of 1-step, 2-step, 3-step and 4-step probes is 50, 90, 50, and 10, respectively.

By probing multiple hash buckets per table, the multi-probe LSH method of the present invention can greatly reduce the number of hash tables while finding desired similar objects. A sensitivity question is whether this approach generates a larger candidate set than the other approaches or not. Table 4 shows the ratio of the average candidate set size to the dataset size for the cases in Table 2. The result shows that the multi-probe LSH approach has similar ratios to the basic and entropy-based LSH approaches.

| | |
|---|---|
| image | audio |

| method | recall | C/N (%) | recall | C/N (%) |
|---|---|---|---|---|
| basic | 0.96 | 4.4 | 0.94 | 6.3 |
| entropy | 0.96 | 4.9 | 0.94 | 6.8 |
| multi-probe | 0.96 | 5.1 | 0.94 | 7.1 |
| basic | 0.93 | 3.3 | 0.92 | 5.7 |
| entropy | 0.93 | 3.9 | 0.92 | 5.9 |
| multi-probe | 0.93 | 4.1 | 0.92 | 6.0 |
| basic | 0.90 | 2.6 | 0.90 | 5.0 |
| entropy | 0.90 | 3.1 | 0.90 | 5.6 |
| multi-probe | 0.90 | 3.0 | 0.90 | 5.3 |

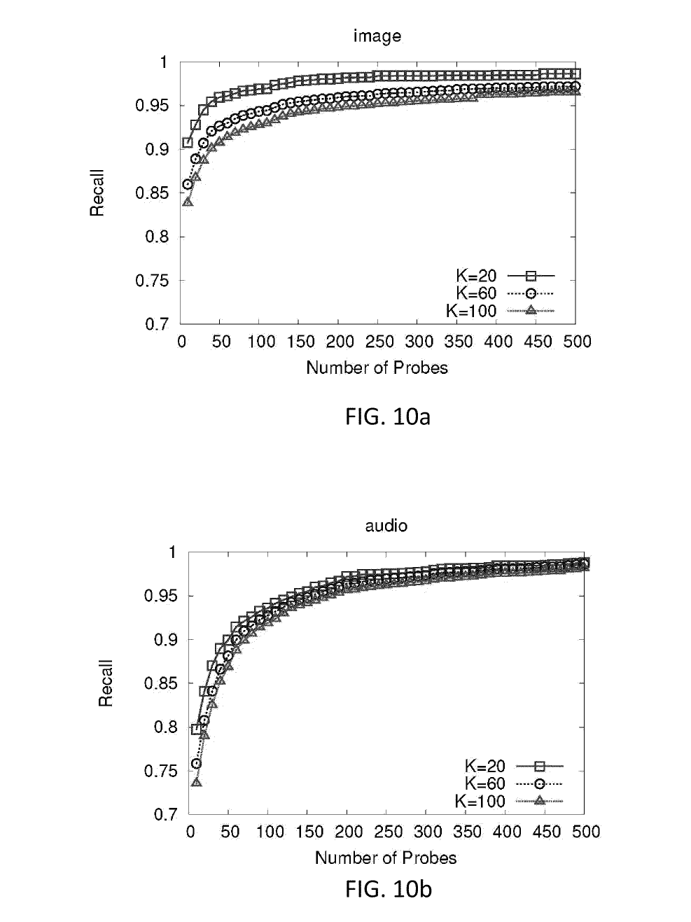

In all examples presented above, we have used K=20 (number of nearest neighbors). Another sensitivity question is whether the search quality of the multi-probe LSH method of the present invention is sensitive to different K values. FIG. 10 shows that the search quality is not so sensitive to different K values. For the image dataset, there are some differences with different K values when the number of probes is small. As the number of probes increases, the sensitivity reduces. For the audio dataset, the multi-probe LSH achieves similar search qualities for different K values.

The different sensitivity results in the two datasets appear to be due to the characteristics of the datasets. As shown in Table 2, for the image data, a 0.90 recall corresponds to a 1.049 error ratio, while for the audio data, the same 0.90 recall corresponds to a 1.004 error ratio. This means that the audio objects are much more densely populated in the high-dimensional space. In other words, if a query object q's nearest neighbor is at distance r, there are many objects that lie within cr distance from q. This makes the approximate nearest neighbor search problem easier, but makes high recall values more difficult. However, for a given K, the multi-probe LSH method can effectively reduce the space requirement while achieving desired search quality with more probes.

The examples presented herein show that the multi-probe LSH method of the present invention is much more space efficient than the basic LSH and entropy-based LSH methods to achieve desired search accuracy and query time. The multi-probe LSH method reduces the number of hash tables of the basic LSH method by a factor of 14 to 18 and reduces that of the entropy-based approach by a factor of 5 to 8.

We have also shown that although both multi-probe and entropy-based LSH methods trade time for space, the multi-probe LSH method is much more time efficient when both approaches use the same number of hash tables. The examples further show that the multi-probe LSH method can use ten times fewer number of probes than the entropy-based approach to achieve the same search quality.

Two probing sequences for the multi-probe LSH method were presented in the examples. The results show that the query-directed probing sequence is superior to the simple, step-wise sequence. By estimating success probability, the query-directed probing sequence typically uses an order-of-magnitude fewer probes than the step-wise probing approach. Although the analysis presented herein is for a specific LSH function family, the general technique of the present invention applies to other LSH function families as well.

The examples presented herein compared the basic, entropy-based and multi-probe LSH methods in the case that the index data structure fits in main memory. the results indicate that 2 GB memory will be able to hold a multi-probe LSH index for 60 million image data objects, since the multi-probe method is very space efficient. For even larger datasets, an out-of-core implementation of the multi-probe LSH method of the present invention in which the index is stored externally will be apparent to those of skill in the art. Although the multi-probe LSH method can use the LSH forest method to represent its hash table data structure to exploit its self-tuning features, the embodiments described herein used the basic LSH data structure for simplicity.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A computer-implemented method for searching a plurality of stored objects comprising the steps of:
(A) placing data objects in a hash table;
(B) generating an ordered sequence of locations (probing sequence) in the hash table from a query object; and
(C) examining data objects in the hash table locations in the generated ordered sequence to find objects whose relationships with the query object satisfy a certain predetermined function defined on pairs of objects.

2. A computer-implemented method for searching a plurality of stored objects comprising according to claim 1, wherein the predetermined function on pairs of objects determines whether the pair of objects is similar.

3. A computer-implemented method for searching a plurality of stored objects comprising according to claim 2, wherein the predetermined function on pairs of objects determines similarity based on a distance function computed on the pair of objects.

4. A computer-implemented method for searching a plurality of stored objects comprising according to claim 2, wherein the predetermined function on pairs of objects determines whether one object can be transformed to the other object by applying a set of specified transformations.

5. A computer-implemented method for searching a plurality of stored objects comprising according to claim 1, wherein the predetermined function on pairs of objects determines whether a significant portion of one object is similar to a significant portion of the other object.

6. A computer-implemented method for searching a plurality of stored objects comprising according to claim 5, wherein the predetermined function on pairs of objects determines whether a significant portion of one object can be transformed to a significant portion of the other object by applying a set of specified transformations.

7. A computer-implemented method for searching a plurality of stored objects comprising according to claim 1, wherein a plurality of hash tables are used.

8. A computer-implemented method for searching a plurality of stored objects comprising according to claim 1, wherein the step of placing data objects in a hash table comprises the placing each data object in the hash table by applying a collection of hash functions to the object and using the result to determine a location in the hash table.

9. A computer-implemented method for searching a plurality of stored objects comprising according to claim 1, where the sequence of locations is determined by first applying a collection of hash functions to a query object and using the result to determine the sequence of locations in the hash table.

10. A computer-implemented method for searching a plurality of stored objects comprising according to claim 1, where a union of the data objects contained in hash table locations in the probing sequence is examined to find data objects close to the query object.

11. A computer-implemented method for searching a plurality of stored objects comprising according to claim 10, where a prefix of the probing sequence is used to obtain a tradeoff of quality and running time.

12. A computer-implemented method for searching a plurality of stored objects comprising according to claim 9, wherein the sequence of locations is generated by computing collections of hash function values having small distances to the collection of hash function values generated for the query object.

13. A computer-implemented method for searching a plurality of stored objects comprising according to claim 12, where the collection of hash function values are ordered by distance to the collection of hash function values for the query object.

14. A computer-implemented method for searching a plurality of stored objects comprising according to claim 13, where the distance function used is a hamming distance.

15. A computer-implemented method for searching a plurality of stored objects comprising according to claim 14, where the distance function is a weighted hamming distance.

16. A computer-implemented method for searching a plurality of stored objects comprising according to claim 15, where the weights are lower for those hash functions where objects close to the query object are more likely to have different hash function values from the hash function value for the query object.

17. A computer-implemented method for searching a plurality of stored objects comprising according to claim 12, where the probing sequence is obtained by a sequence of transformations applied to the hash function values generated for the query object.

18. A computer-implemented method for searching a plurality of stored objects comprising according to claim 17, where the sequence of transformations is computed from the query object.

19. A computer-implemented method for searching a plurality of stored objects comprising according to claim 18, where a set of sequences of transformations are pre-computed and one of them is selected based on the query object.

20. A computer-implemented method for searching a plurality of stored objects comprising according to claim 1, wherein said step of placing data objects in a hash table comprises the steps of:
producing a compact sketch for each object; using a feature extraction procedure; and
placing said data objects into multiple hash tables based upon said sketches.

21. A computer-implemented method for searching a plurality of stored objects comprising according to claim 1, wherein said step of generating an ordered sequence of hash table locations comprises the steps of:
producing a compact sketch of a query object; and
identifying locations in the hash table based upon the compact sketch of the query object.
